(19) United States
(12) Patent Application Publication
(10) Pub. No.: US 2018/0177319 A1
(43) Pub. Date: Jun. 28, 2018

(54) SYSTEM AND METHOD FOR SECURE LOCK BOX WITH NEAR PROXIMITY AWARENESS

(71) Applicants: DAN WILLIS, Lafayette, CO (US); CY E. BUTTE, ARVADA, CO (US)

(72) Inventors: DAN WILLIS, Lafayette, CO (US); CY E. BUTTE, ARVADA, CO (US)

(21) Appl. No.: 15/391,559

(22) Filed: Dec. 27, 2016

(51) Int. Cl. A47G 29/14; G06Q 10/08; G06Q 10/10; A47G 29/122; A47G 29/124

(52) U.S. Cl. CPC A47G 29/141; G06Q 10/0833; G06Q 10/1097; A47G 29/1225; A47G 2029/147; A47G 2029/1226; A47G 2029/145; A47G 2029/149; A47G 2029/146; A47G 29/124

(57) ABSTRACT

Provided are a system and method for a secure lock box with near proximity awareness. The system includes a lock box housing defining at least one enclosable space for the receipt of a package, the lock box housing having a sealable aperture for accessing the enclosable space and an electronic lock structured and arranged to seal the aperture and enclose the space. The lock box housing further encloses a processor, a near proximity device structured and arranged to actively detect a Package Attribute from a package proximate to the lock box housing, a network component coupled to the processor, and non-volatile memory coupled to the processor having executable instructions to direct the operations of the near proximity device and the electronic lock. The system also includes a a scheduler structured and arranged to establish a schedule of delivery within the non-volatile memory including at least one Defined Characteristic for the operation of the electronic lock in response to the near proximity device detecting from a proximate package a Package Attribute corresponding to the Defined Characteristic. An associated method of use is also provided.

### FIELD OF THE INVENTION

The present invention relates generally to the field of automated systems for the safe and secure receipt of delivery items, and more specifically to a secure lock box with near proximity awareness.

### BACKGROUND

The shopping experience has changed considerably over the past years as more and more people turn to online retailers or vendors to order desired items for delivery. Typically this delivery is directed to a user's home.

Although delivery to homes is not a new development, in very recent times there has been an alarming increase in theft of packages left unattended on doorsteps. News stories around the holidays frequently include video captured by the distraught resident, that first shows a delivery agent dropping the package off and then moments later a thief running up to snatch the package and take it away.

This nasty practice has become common enough that the news media has coined the term “porch pirates”—it truly is no laughing matter. While the vast majority of packages are delivered without issue, it is still estimated that some 23 million Americans have had packages stolen from their homes, dwellings or premises before they could be opened.

In some cases, a secure lock box may be provided for the receipt of a delivery item, but merely providing the physical box does not necessarily resolve all issues. How is the box to be opened? Who has permission to open the box and how is this permission and ability granted? Are there safeguards to prevent the wrong party from opening the box? How much space does it require? These are only a few of the many questions and issues that may exist, but the desire for such enhanced security has not deterred efforts.

Lock boxes have long existed in train stations, bus stations, amusement parks and other locations where people may wish to leave items safely for some period of time. These lock boxes are generally engaged by inserting a coin or token that permits the user to remove a key. While certainly viable for short term storage, these are generally single operator systems, for he or she who removes the key is the same party who generally must reinsert the key to open the lock box.

Another option is to provide a secure lock box at a post office or other mail/package shipping facility. But when a package is then delivered to this remote facility the intended recipient must travel to that facility, which may be far from convenient. If the delivered item is heavy or bulky it may also be difficult to transport.

Secure boxes for homes, such as locking mail boxes or boxes connected by a delivery shoot, do exist. The shoot option may well allow delivery items to be received but not easily removed, and generally requires additional space to accommodate the shoot. Further, the shoot may be smaller then the internal volume of the box which limits the size of the item that may be delivered. And further, if the shoot connects to the top of the receiving chamber, there can be an issue of damage to fragile items that fall from the shoot into the secured receiving chamber.

Use of a lock to secure the box may eliminate the issues with the shoot, but locks present other issues. If the lock requires a physical key, then the delivery person must be provided with this key. As packages may be delivered by any number of delivery companies, the use of a physical key is impractical.

When the lock is electronic such that it responds to a code, there is the obvious problem that the code must be changed periodically to prevent unauthorized access to the box. The code must also be shared with the delivery agent and this may impose additional and undesired record keeping on the part of the delivery agent.

Some security systems have attempted to address some of these issues, such as for example: U.S. Pat. No. 7,815,112 to Volpe et al., entitled Secure Parcel Delivery In The Absence Of The Intended Recipient, U.S. Pat. No. 9,418,495 to Mackin et al., entitled Electronic Lock Apparatus, Method And System; and US Patent Application 2014/0068247 to Davis et al., entitled Security Device Access.

Davis, US Patent Application 2014/0068247, sets forth an invention for securely controlling a security locking device to limit access to a restricted resource or area using a symmetric encryption key and or cryptographic primitives, independent of outside communication.

Moreover, Davis specifically teaches that the security locking device 120 is NOT on a network. This is so it can't be hacked, but this also means that it can't receive network traffic indicating what the next security code will be, or when the code should be valid—any and all valid codes are determined by pre-establishing a symmetric encryption key and/or cryptographic primitives put into the security locking device 120 at the time it is built.

According to Davis, the security locking device 120 will generate a plurality of security access codes using a preconfigured symmetric key. A control server generates at least one candidate access code using the same pre-configured symmetric key and then forwards them to a delivery agent, the access codes being valid for varying time intervals. When the delivery agent arrives he or she provides the candidate code to the delivery box, and the delivery box in turn evaluates the candidate code with the pre-configured key and validity time frame—and if both match the security locking device 120 will be opened.

Although beneficial in some situations, as the security box is intentionally isolated from outside communication it could become out of phase with the control server, and thus candidate access codes would fail. In addition, the delivery agent is charged with both acquiring the candidate access code and providing it to the security box by way of a keypad. In many situations such as inclement weather or poor lighting, the use of a keypad, touch pad or other interface requiring direct human interaction for a delivery agent to enter information may be at the very least a burden if not an outright danger to the delivery agent.

Mackin, U.S. Pat. No. 9,418,495, sets forth electronically activated locks for doors or package containers that are activated by access codes. Under Mackin, either the box 1/101 or the Remote Server 27 generates the Access Code with the use of a Code Generator 21 (box)/41 (server) that is reliant upon an Electronic Timer 23 (box)/42 (server) and a seed code. Because time is a key factor in the generation of the Access Code, and each generated code is only valid for a very specific period of time, keeping the Remote Server 27 and the Box 1 in time synchronization is critically important.

Rather than rely on something as common as NTP, Mackin teaches the use of multiple Access Codes—specifically a plurality of access codes in a first series and a plurality of access codes in a second series, each having a very specific period of validity. The periods of validity overlap between the first series and the second series. These multiple overlapping series of Access Codes are used by the system to determine if a time adjustment should be made.

Although not isolated as Davis directs, Mackin requires a good bit of record keeping regarding the multiple codes and their overlapping series. As with Davis, under Mackin the delivery agent is charged with both acquiring the access code and providing it to the security box by way of a keypad, touch interface or other user interface. In many situations such as inclement weather or poor lighting, the use of a keypad, touch base or other user interface may be at the very least a burden if not an outright danger to the delivery agent.

Typically the seed code is unique to each box. Because Mackin is fixated on the use of multiple overlapping series of Access Codes, and these codes being either generated by the Box itself, or a Remote Server, the Mackin reference falls quite short of teaching an access code for a box based on an Order Number.

Volpe, U.S. Pat. No. 7,815,112 provides yet another option for a securely receiving a parcel when the intended recipient is not present. Under Volpe, the tracking number is enabled as an access code, which when input by a delivery person unlocks the receptacle 105. Perhaps simpler then Mackin and/or Davis, Volpe clearly requires the delivery person to input the tracking number through a keypad 101, keyboard or touch screen display.

Moreover, as with Mackin and Davis, the Volpe security box is passive with respect to the receipt of the delivery, as the delivery agent must input the code. Where there are many packages to deliver, the weather is bad, the lighting poor, the neighborhood unsafe, or other factors, requiring the delivery agent to be the active party for inputting the code may be at the very least a burden if not an outright danger to the delivery agent. Further still, as Mackin, Davis, Volpe and other devices requiring direct input from the delivery agent in the form of typing, there is always the chance for the delivery agent to make a mistake. Where tracking numbers may be 16, 20, 30 or more characters in length, the chance of an error increases. As font size and lighting may be poor, again the opportunity for an error may increase. Checking and re-entering a number may further burden, delay and potentially subject the delivery agent to danger.

Indeed taking time to enter a code, removing gloves during a freezing rain or ice storm, and/or simply being fixated on a keypad and not one's surroundings may delay, discomfort, and potentially subject the delivery agent to harm.

Hence there is a need for a system and method that is capable of overcoming the above identified challenges and shortcomings.

### SUMMARY

Our invention solves the problems of the prior art by providing novel systems and methods for a secure lock box, and more specifically for a secure lock box with proximity.

In particular, and by way of example only, according to one embodiment of the present invention, provided is a system for a secure lock box with near proximity awareness, including: a lock box housing defining at least one enclosable space for the receipt of a package, the lock box housing having a sealable aperture for accessing the enclosable space and an electronic lock structured and arranged to seal the aperture and enclose the space, the lock box housing further enclosing: a processor; a near proximity device structured and arranged to actively detect a Package Attribute from a package proximate to the lock box housing; a network component coupled to the processor; a non-volatile memory coupled to the processor having executable instructions to direct the operations of the near proximity device and the electronic lock; and a scheduler structured and arranged to establish a schedule of delivery within the non-volatile memory including at least one Defined Characteristic for the operation of the electronic lock in response to the near proximity device detecting from a proximate package a Package Attribute corresponding to the Defined Characteristic.

In yet another embodiment, provided is a system for a secure lock box with near proximity awareness, including: a lock box housing defining at least one enclosable space for the receipt of a package, each enclosable space accessible through an aperture sealable by a door at least partially attached to the lock box housing, each space having an electronic lock for engaging the door with the lock box housing to enclose the space, the lock box housing further enclosing: a processor; a near proximity device structured and arranged to actively detect at least one Package Attribute from a package proximate to the lock box housing; a network component coupled to the processor; a non-volatile memory coupled to the processor having executable instructions to direct the operations of the near proximity device and the electronic lock; and a remote scheduling application to establish via the network component a schedule of delivery within the non-volatile memory including at least one Defined Characteristic for the operation of the electronic lock in response to the near proximity device detecting from a proximate package a Package Attribute corresponding to the Defined Characteristic.

Further still, for another embodiment, provided is a method for receipt of a package by a secure lock box with near proximity awareness, including: providing a lock box housing defining at least one enclosable space for the receipt of a package, each enclosable space accessible through an aperture sealable by a door at least partially attached to the lock box housing, each space having an electronic lock for engaging the door with the lock box housing to enclose the space, the lock box housing further enclosing: a processor; a near proximity device structured and arranged to actively detect at least one Package Attribute from a package proximate to the lock box housing; a network component coupled to the processor; a non-volatile memory coupled to the processor having executable instructions to direct the operations of the near proximity device and the electronic lock; providing at least one scheduling application to establish a schedule of delivery within the non-volatile memory including at least one Defined Characteristic for the operation of the electronic lock; using the scheduling application to establish the schedule of delivery with at least one Defined Characteristic; and unlocking the electronic lock in response to the near proximity device detecting a proximate package having a Package Attribute corresponding to the Defined Characteristic.

And still further, in yet another embodiment, provided is method for receipt of a package by a secure lock box with near proximity awareness, including: providing a lock box housing defining at least one enclosable space for the receipt of a package, each enclosable space accessible through an aperture sealable by a door at least partially attached to the lock box housing, each space having an electronic lock for engaging the door with the lock box housing to enclose the space, the lock box housing further enclosing: a processor; a near proximity device structured and arranged to actively detect at least one Package Attribute from a package proximate to the lock box housing; a network component coupled to the processor; a non-volatile memory coupled to the processor having executable instructions to direct the operations of the near proximity device and the electronic lock; establishing a schedule of delivery including at least one Defined Characteristic for the operation of the electronic lock, the schedule established within the non-volatile memory; detecting a Package Attribute by the near proximity device when a package having the attribute is proximate to the lock box housing; evaluating the detected Package Attribute to the Defined Characteristic, and unlocking the electronic lock in response to the detected Package Attribute corresponding to the Defined Characteristic.

### BRIEF DESCRIPTION OF THE DRAWINGS

At least one method and system for secure lock box with proximity awareness will be described, by way of example in the detailed description below with particular reference to the accompanying drawings in which like numerals refer to like elements, and:

FIG. 1 illustrates a high level diagram of a system for secure a secure lock box with proximity awareness in accordance with at least one embodiment;

FIG. 2 is an enlarged illustration of the secure lock box housing and a package in accordance with at least one embodiment

FIGS. 3A and 3B are conceptual illustrations for the operation of the secure lock box with proximity awareness in accordance with at least one embodiment;

FIGS. 4A and 4B are further conceptual illustrations for the operation of the secure lock box with proximity awareness in accordance with at least one embodiment;

FIG. 5 illustrates a flow diagram for a method of receiving a package by a secure lock box with proximity awareness in accordance with at least one embodiment; and

FIG. 6 is a block diagram of at least one computer system in accordance with certain embodiments of the present invention.

### DETAILED DESCRIPTION

Before proceeding with the detailed description, it is to be appreciated that the present teaching is by way of example only, not by limitation. The concepts herein are not limited to use or application with a specific system or method for a secure lock box with near proximity awareness. Thus although the instrumentalities described herein are for the convenience of explanation shown and described with respect to exemplary embodiments, it will be understood and appreciated that the principles herein may be applied equally in other types of systems and methods for securely receiving deliveries via a secure receptacle with near proximity awareness.

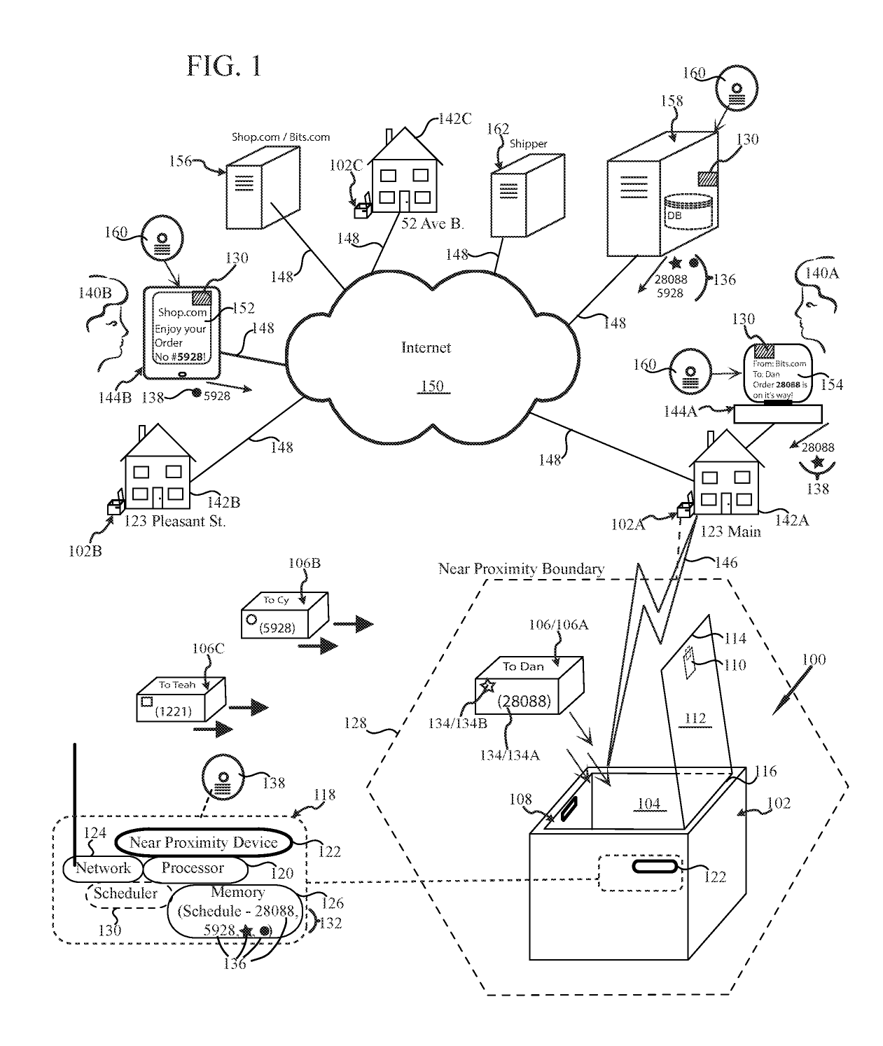

This invention is described with respect to preferred embodiments in the following description with reference to the Figures, in which like numbers represent the same or similar elements. Further, with the respect to the numbering of the same or similar elements, it will be appreciated that the leading values identify the Figure in which the element is first identified and described, e.g., element 100 appears in FIG. 1.

Various embodiments presented herein are descriptive of apparatus, systems, articles of manufacturer, or the like for systems and methods for secure lock box with near proximity awareness. In some embodiments, an interface, application browser, window or the like may be provided that allows the user of the computing device to direct behavior of the computing device.

Moreover, some portions of the detailed description that follows are presented in terms of the manipulation and processing of data bits within a computer memory. The steps involved with such manipulation are those requiring the manipulation of physical quantities. Generally, though not necessarily, these quantities take the form of electrical or magnetic signals capable of being stored, transferred, combined, compared and otherwise manipulated. Those skilled in the art will appreciate that these signals are commonly referred to as bits, values, element numbers or other clearly identifiable components.

It is of course understood and appreciated that all of these terms are associated with appropriate physical quantities and are merely convenient labels applied to these physical quantifies. Moreover, it is appreciated that throughout the following description, the use of terms such as “processing” or “evaluating” or “receiving” or “outputting” or the like, refer to the action and processor of a computer system or similar electronic computing device that manipulates and transforms data represented as physical (electrical) quantities within the computer system's memories into other data similarly represented as physical quantities within the computer system's memories.

The present invention also relates to apparatus for performing the operations herein described. This apparatus may be specifically constructed for the required purposes further described below, or the apparatus may be one or more general purpose computer system(s) selectively adapted or reconfigured by one or more computer programs stored in the computer upon computer readable storage medium suitable for storing electronic instructions.

To further assist in the following description, the following defined terms are provided.

“User”—typically a person or at the very least a computing device used by a person who is has ordered the package or otherwise requested its delivery. With respect to the User as a person, this person is most often also the package recipient, though it is of course understood and appreciated that a first person could order a package that is directed to a second person.

“Secure Lock Box with Near Proximity Awareness”—also referred to as SBPA is the physical lock box that is operable to receive a package for a User when the User is not otherwise present to receive the package personally. As further described below, the SBPA is an active device which can and will automatically detect a Package Attribute from a package having such an attribute when the package is brought into near proximity of the SBPA so that the Near Proximity Device of the SBPA can detect the Package Attribute.

“Near Proximity Device”—also referred to as the NPD, is the device component of the SBPA that is structured and arranged to detect a Package Attribute when the box is within a near proximity to the SBPA. While this range of proximity is dependent upon the specific form of the NPD (i.e., about 100 meters for Bluetooth, 1 to 15 meters for RFID, generally less than 2 meters for optical scan, perhaps 1-15 for an acoustic element) it is to be specifically understood and appreciated that the NPD is an active component sensing localized Package Attributes when present. For an A combination of elements may function collectively as the NPD, such as for example a motion detector and an optical scanner—when the motion detector senses motion proximate to the SBPA the optical scanner can be activated.

“Package Attribute”—is an identifiable characteristic of the package, such as a tracking number, identification element, specific sound, bar code, QR code, or other element which may be applied to the package or placed within the package, and which can be detected by the NPD when the package is within the appropriate proximity for the selected Package Attribute to be detected by the NPD. Moreover the Package Attribute may be any element that may be detected by the NPD from the package and evaluated by the SBPA against a Defined Characteristic in determining if the package should be accepted and the SBPA opened to receive the package.

“Delivery Agent”—the party physically delivering the package and therefore bringing the package to within the required proximity for the NPD to detect the Package Attribute. It is to be understood and appreciated that while the Delivery Agent may be required to orient the package towards the NPD, the Delivery Agent's roll is passive when compared to other secure lock box systems—the Delivery Agent brings the Package to the SBPA, and proximately places the package adjacent to the SBPA. When a Package Attribute corresponding to the Defined Characteristic is detected and verified such that the lock is disengaged by the Secure Lock Box, the Delivery Agent then dispose the package within the SBPA.

“Defined Characteristic”—an element of data that is provided to the SBPA, such as but not strictly limited to a tracking number, an order ID, a graphic, bar code, QR code, numeric sequence, alphanumeric sequence, tonal pattern, date, time, hash value, or other data element(s) that are used in the evaluation of the Package Attribute by the SBPA to determine if the package should be accepted. Moreover the Defined Characteristic may be any data element that may be used by the SBPA in evaluating a detected Package Attribute in determining if the package should be accepted and the SBPA opened to receive the package. In varying embodiments the Defined Characteristic is established before the Package and/or Package Attribute is detected, but for at least one embodiment the SBPA may poll one or more remote computer systems to ensure that a change in delivery scheduled was not inadvertently overlooked.

“Scheduler”—an element, module or application which adapts a user's device, a remote server, a shipper's computer device, or another computing system including the control circuitry of the secure lock box to establish the schedule of delivery.

With respect to the above defined terms, it is understood and appreciated that for at least one embodiment, each module or system incorporated to provide SBPA is implemented as a collection of independent electronic circuits packages as a unit upon a printed circuit board, or as a chip attached to a circuit board or other element of a computer so as to provide the basic function within a computer. In varying embodiments, one or more modules may also be implemented as software that adapts a computer to perform a specific task or basic function as part of a greater whole. Further still, in yet other embodiments one or more modules may be provided by a mix of both software and hardware and independent electronic circuits.

To briefly summarize, provided for at least one embodiment is a system for a Secure Lock Box with Near Proximity Awareness. In general, this system includes a lock box housing defining at least one enclosable space for the receipt of a package. The lock box housing also has a sealable aperture for accessing the enclosable space and an electronic lock structured and arranged to seal the aperture and enclose the space. The lock box housing further encloses a processor: a Near Proximity Device structured and arranged to actively detect a Package Attribute from a package proximate to the lock box housing; a network component coupled to the processor; a non-volatile memory coupled to the processor having executable instructions to direct the operations of the near proximity device and the electronic lock. The system also includes a scheduler structured and arranged to establish a schedule of delivery within the non-volatile memory including at least one Defined Characteristic for the operation of the electronic lock in response to the Near Proximity Device detecting from a proximate package a Package Attribute corresponding to the Defined Characteristic.

This summary may be more fully appreciated with respect to the following description and accompanying figures.

Turning now to the figures, and more specifically to FIG. 1, there is shown a high level diagram of an embodiment of a system for a secure lock box with near proximity awareness (“SBPA”) 100 in accordance with at least one embodiment. As shown, for at least one embodiment SBPA 100 has a lock box housing 102, of which lock box housings 102A, 102B, and 102C are exemplary defining at least one enclosable space 104 for the receipt of a package 106, of which packages 106A, 106B and 106C are exemplary.

The lock box housing 102 also has a sealable aperture 108 for accessing the enclosable space 104 and an electronic lock 110 structured and arranged to seal the aperture 108 and enclose the space 104. For at least one embodiment the sealable aperture 108 is provided as a door 112 having a front portion 114 and a rear portion 116, the rear portion 116 pivotally mounted to the lock box housing 102 so as to seal aperture 108. Of course in varying embodiments, the sealable aperture 108 may be provided as a clam shell structure, a roll top gate or other structure that may be opened and closed without departing from the scope of the present invention.

As shown for ease of illustration in FIG. 1, for at least one embodiment, the electronic lock 110 is disposed upon or otherwise incorporated as part of the door 112, and structured and arranged to engage with the lock box housing 102 when the door 112 is closed. For at least one alternative embodiment the electronic lock 110 may be disposed upon, or other wise incorporated as, part of the lock box housing 102, and structured and arranged to engage with the door 112 when the door 112 is closed.

The lock box housing 102 further encloses control circuitry 118 including at least one processor 120, a Near Proximity Device (“NPD”) 122, a network component 124 and a non-volatile memory 126. As represented by dotted line 128 surrounding SBPA 100, there is a near proximity boundary 128 about SBPA 100.

The system of SBPA 100 also includes at least one scheduler 130 which is structured and arranged to establish a schedule of delivery 132 within the non-volatile memory 126 including at least one Defined Characteristic 136 for the operation of the electronic lock 110 in response to the NPD 122 detecting from a proximate package, i.e., package 106A, a Package Attribute 134 that corresponds to the Defined Characteristic 136.

Moreover, the control circuitry 118 is structured and arranged such that the non-volatile memory 126 contains processor executable instructions to direct the operation of the network component 124, the NPD 122 and the electronic lock 110. The delivery schedule as established by the scheduler 130 further permits the processor 120 to direct the operation of the electronic lock 110 when an appropriate package 106 is proximate to the SBPA 100, and more specifically, within the operating proximity of the NPD 122.

For at least one embodiment, the processor executable instructions for the control of the electronic lock 110, the NPD 122, the network component 124, and the creating/editing and execution of the delivery schedule are provided by a non-portable media 138, such as a disc, USB jump drive or other appropriate device.

As shown, package 106A has Package Attributes 134, shown as a number sequence 134A and as an image 134B. Although shown to have two Package Attributes 134, for the sake of discussion herein, it should be understood and appreciated that in varying embodiments a package 106 to be received by SBPA 100, and more specifically the lock box housing 102, may have only one Package Attribute 134, or a plurality of Package Attributes 134. As noted above, when a package 106, is within the near proximity boundary 128 the Package Attribute(s) 134 may be actively detected by the NPD 122.

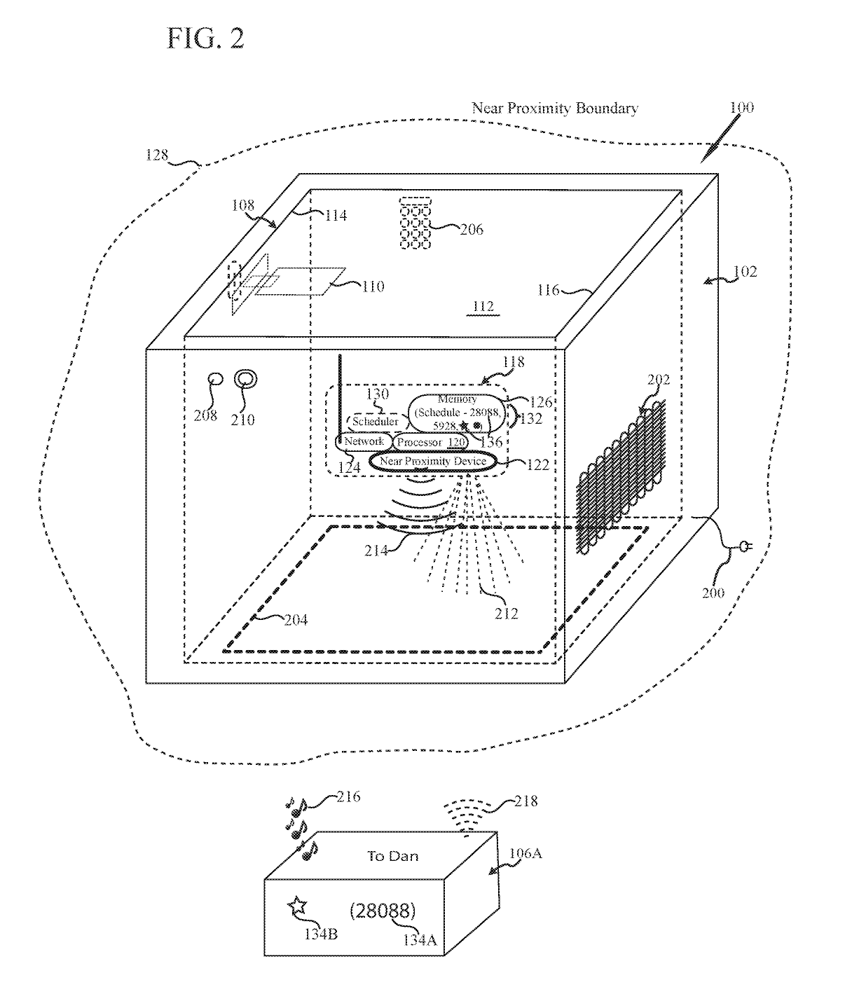

FIG. 2 presents an enlarged view of the lock box housing 102 portion of exemplary SBPA 100 and package 106A. As may be appreciated in this enlarged drawing, the control circuitry 118 consisting of at least the at least one processor 120, Near Field Proximity Device (“NPD”) 122, network component 124 and non-volatile memory 126 are all disposed within the lock box housing for at least one embodiment.

Further, although in varying embodiments the lock box housing 102 may be a flexible material, for at least one embedment the lock box housing 102 is constructed of a non-flexible material such as a metal, plastic, polycarbonate, or other material that is difficult to penetrate and thereby provides an added safety measure of protection for the packages to be disposed therein.

Moreover, for at least one embodiment, the lock box housing 102 is intended to be a self supporting structure that may be affixed to a patio, porch, wall or other area of the building or dwelling where it is placed by the User to receive packages 106. For at least one embodiment, the lock box housing 102 may be built into, or otherwise incorporated as a part of the building structure. Lock box housing 102 also provides appropriate electrical wiring 200 for connection to a buildings electrical system, and in varying embodiments may also include a backup battery system.

In further addition, for at least one embodiment the lock box housing 102 may also include a mail slot to receive letters. These letters need not also have Package Attributes, but may be received and securely held for the user as an alternative to a traditional mail box which is generally unsecured.

As is also shown in FIG. 2, for at least one embodiment, the lock box housing 102 may further provide internal environmental control 202, beyond mere insulation. More specifically, lock box housing 102 may provide internal environmental control 202 such as a heating element and/or cooling element to maintain a user specified temperature ranging from hot or cold, such as near boiling to below freezing. As such, embodiments of SBPA 100 may easily accommodate the receipt of medications that must be refrigerated or maintained at or below freezing, or even the delivery of food items which should be kept hot.

As is also shown in FIG. 2, for at least one embodiment, the lock box housing 102 may also include a weight scale 204 such that when a package 106 is disposed within the enclosable space 104, SBPA 100 may detect the weight and thereby confirm receipt. Further, for at least one embodiment, SBPA 100 may be provided with the expected weight of the package 106 and may thereby confirm receipt of the expected package both by the Package Attribute(s) 134 (e.g. Package Attributes 134A and 103B) as well as the measured weight. In addition, the presence of a scale permits SBPA 100 to alert the User 140 should a received package 106 be improperly removed.

For at least one embodiment, the lock box housing 102 is effectively free of external buttons and controls. A physical keyhole may be provided for manual control of the electronic lock 110, and user controls 206 may be provided within the lock box housing 102 in varying embodiments for enhanced security. Further a USB port, network port or other user interface may be provided internally for direct connection of a UD. For yet alternative embodiments, the lock box housing 102 may provide at least one external status light 208 which may signal to the delivery agent or user that it is on, that a packager has been received, that the package is rejected, etc . . . . In addition, the lock box housing 102 may provide an exterior light to illuminate the lock box housing 102 and facilitate the delivery agent's delivery of a package at night.

Further still, for at least one embodiment the lock box housing 102 may incorporate a camera 210 and or microphone such that it may record the delivery and or the presence of persons in proximity to SBPA 100. Additional external buttons and or input devices may also be provided as well, however it is expressly understood and appreciated that these are not intended to usurp the active nature of the NPD 122 to detect Package Attributers without requiring the delivery agent to initiate the process by entering a code or otherwise actively engaging in the more than the mere delivery process.

As is also shown with respect to FIG. 2, the near proximity boundary 128 is shown with a more irregular shape. Where the near proximity device 122 is an optical scanner the near proximity boundary 128 will be the field of view of the optical sensor camera. Where the NPD 122 is an RFID, Bluetooth, AdHoc or other non-line of sight device, the near proximity boundary 128 may still be irregular given the material of the lock box housing 102 itself and/or the proximity of the building.

Moreover it is to be understood and appreciated that in general the NPD 122 will have a greater active ability to sense the Package Attribute 134 from a package 106 that is approaching from an unobstructed direction. In addition, although the illustrations and discussion herein describe embodiments having one NPD 122, it is to be understood and appreciated that at least one embodiment of SBPA 100 includes at least two different NPDs 122, such as for example an optical scanner and an/or RFID system.

As is conceptually illustrated by scan lines 212 and radio frequency lines 214, the NPD 122 is an active device seeking the detection of one or more Package Attributes 134 when a package is brought within the near proximity boundary 128. More specifically, it is to be understood and appreciated that the delivery agent is a passive party, proximately placing the package 106 adjacent to the secure lock box 102 and disposing the package 106 within the enclosable space 104 upon the NPD 122 detecting a Package Attribute 134 corresponding to the Defined Characteristic 136.

As may also be appreciated in FIG. 2, the Package Attribute(s) 134 of package 106 may be static elements, such as text, a symbol, bar code, QR code or other static element(s) present on or at least perceived through the exterior of the package 106. Package Attribute(s) 134 may also emanate from the package, such as sound waves 216, RFID signals, Bluetooth, AdHoc or other transmissions 218. These transmissions 216/218 may be triggered by the NPD 122, such as with RFID, or may be provided by the package 106 at scheduled intervals.

Returning to FIG. 1, it may be appreciated that SBPA 100 is intended to securely receive packages 106 on behalf of a recipient, who is typically also the User 140 of SBPA 100, and the party who initiated the order for the package 106. As such, embodiments of BPA 100 are typically installed at homes, dwellings, premises—e.g., premises 142, of which premises 142A, 142B and 142C are exemplary, each having a corresponding instance of SBPA 100, and more specifically lock box housings 102A, 102B, and 102C accordingly.

Each User 140 has a corresponding User Device, hereinafter “UD” or first device 144, which is understood and appreciated to be a computing device having at least one processor and network access, such as but not limited to a desktop computer, laptop computer, smart phone, tablet computer, or other computing device. For at least one embodiment, each User's home 142 also has a local area home network 146; thought local area home network is only shown for User's premises 142. Moreover, each User's 140 home network 146, and UD 144 has, or may establish communication links 148 for access to and communication with other systems connected to the Internet 150.

The network component 124 is typically intended for connection to a User's home network 146 such as by a direct wire connection or a wireless network connection. Moreover, for at least one embodiment, the network component 124 is a wireless network component. By way of the connection to the User's home network 146, the SBPA 100, and more specifically the control circuitry 118 of lock box housing 102 can access the Internet 150. The use of a wireless network component 124 may be advantageous in that an additional network line need not be supplied to lock box housing 102.

Though intended for use with a User's premises 142, and more specifically a User's home network 146, it is of course understood and appreciated that in varying embodiments the network component can be a cellular network device such that lock box housing 102 may directly access the Internet 150 without use of the User's home network 146.

As noted above, the scheduler 130 is structured and arranged to establish a schedule of delivery 132 within the non-volatile memory 126. This may be accomplished in a variety of different ways in varying embodiments. Moreover, for at least one embodiment the scheduler 130 is provided as a remote component, module or application provided by a user's UD 144 as a web browser plugin adapting the user's UD 144 to obtain the Defined Characteristic 136 from an order confirmation displayed to the user, such as shown with exemplary browser text 152.

For at least one alternative embodiment, the scheduler 130 is provided as a remote component, module or application provided by a user's UD 144 to parse email, the remote component, module or application adapting the user's UD 144 to obtain the Defined Characteristic 136 from an order confirmation email sent to the user, such as shown with exemplary email text 154. Indeed, for at least one embodiment the scheduler 130 provided by a User's UD 144 may be structured and arranged to parse email and act as a web browser plugin, this permitting capture of a Defined Characteristic 136 from an online transaction or a received email.

For still another embodiment, the scheduler 130 is provided as a remote component, module or application provided by a remote seller computer 156 having at least one processor, the remote component, module or application adapting the remote seller computer 156 to obtain the Defined Characteristic 136 from the order process occurring on the remote seller's computer 148.

Each instance of the scheduler 130, or scheduler application may be provided to each computing system by a non-portable computer readable media such as a disc 160, USB drive, or download from a remote third party site, such as for example the Apple App Store.

With respect to embodiments where the scheduler 130 is operable as a web-browser plugin or email parser, the scheduler 130 may be configured to auto-detect tracking or order numbers which may then be displayed to the User 140 for confirmation. In varying embodiments, the User 140 may also be able to select an element, such as confirmation number, tracking number or other element and tag the element for the scheduler as a Defined Characteristic 136.

And for yet another embodiment, the scheduler 130 is provided as a remote component, module or application provided by a remote server 158 having at least one processor, the remote component, module or application adapting the remote server 158 to obtain the Defined Characteristic from the remote seller 148 and or UD 144.

For a package to be received on behalf of a user 140 by SBPA 100 there must be a correlation between the Package Attribute(s) 134 and the Defined Characteristic(s) 136 as noted in the schedule of delivery 132 as established by the scheduler. Moreover the Defined Characteristic 136 is a first identifier, such as a first ID number and the Package Attribute 134 is a second identifier, such as a second ID number. More specifically, for at least one embodiment, the Defined Characteristic 136 is a tracking number and the Package Attribute 134 is a tracking number. Simply put, when the tracking number of the package 106 corresponds to the tracking number in the schedule of delivery 132, SBPA 100 correctly evaluates the package 106 as appropriate to be received.

For many embodiments the Defined Characteristic may be a tracking number or order number that in general will be unique to each order. It is also to be understood and appreciated that Package Attribute(s) 134 need not be unique. Moreover, multiple packages may have the same Package Attribute 134 and be received by SBPA 100. Indeed, the User 140 may create their own Defined Characteristic 136 that the User may then provide to friends or family for the secure drop off of packages 106.

For enhanced security, the pre-defined Package Attribute(s) 134 and the Defined Characteristic(s) 136 may correlate to one another by way of a hash algorithm. Further still, the subset Defined Characteristic(s) 136 may be a subset of the Package Attribute(s) 134—for example if the tracking number is “280885928”, the Defined Characteristic may be “8859” or some other portion of the greater tracking number.

When the processor 120 determines that there is an appropriate correlation between the Package Attribute(s) 134 and the Defined Characteristic(s) 136, such as a match, a hash value relationship, a subset portion or other relationship, the processor 120 directs the operation of the electronic lock 110 so that the package 106 may be received. It should be understood and appreciated that for at least one embodiment this determination by the processor 120 is a local event performed within the control circuitry 118 and does not require external resources such as confirmation by the remote server 158 prior to activation of the electronic lock 110.

For embodiments of SBPA 100 incorporating a remote server, the schedule of delivery 132 for each instance of SBPA 100 may be maintained by the remote server 158 as a remote backup. Should an instance of SBPA 100 lose power or be reset for one reason or another, upon restart it may re-establish its delivery schedule from the remote server 158. In addition, each instance of SBPA 100 may poll the remote server 158 from time to time, such as at preset intervals, to query for updates to the delivery schedule.

As shown, for at least one embodiment the scheduler 130 is a component or module of the SBPA 100 control circuitry 118 within the lock box housing 102. Moreover, multiple instances of the scheduler 130 may exist in varying embodiments. Indeed, the scheduler 130 may exist in a form understood and appreciated to be a distinct application or component of a distinct application which is downloaded or otherwise provided to a UD 144 or other computing device which is used to control. The scheduler may also be an application that is unobtrusively incorporated into an existing application such as a web browser or email application.

In varying embodiments the scheduler 130 may also be structured and arranged to review the shipping records as provided by a remote shipping entity 162, as shipping entities commonly provide websites or API's providing shipping details for packages 106 in route to recipients. Indeed, use of the remote shipping entity 160 may be advantageous in permitting the schedule of delivery 132 to be updated due to unforeseen delays in transit. It should also be understood and appreciated that multiple remote shipping entities may exist—such as but not limited to FedEx, UPS, DHL, the US Mail, etc. . . . . Varying embodiments of SBPA 100 can accept packages 106 having an appropriate Package Attribute 142 corresponding to a Defined Characteristic 136 as determined by the scheduler 130 reviewing the records of any one of these shipping entities, without requiring any change on the part of the shipping entity.

Moreover multiple instances of the scheduler 130 may exist in varying embodiments. Modification of the delivery schedule by multiple instances of scheduler 130 can be handled as atomic transitions to insure that simultaneous, but different schedule adjustments do not occur. Atomic transactions are guaranteed to have either of two outcomes—either complete execution (commit) or leave no trace of execution (abort), and when multiple processes attempt to perform conflicting atomic transactions simultaneously, their atomic nature guarantees that the transactions that succeed are serializable, meaning that they appear to execute one after the other without intermingling. Guaranteeing atomic transactions frees the programmer from concerns over partial updates occurring, which could lead to corruption of data and/or an errant view of the data. Moreover, to interact atomically is to interact via atomic transactions, such that each interaction either is or is not completely successful.

It is also to be understood and appreciated that SBPA 100, the home network 146, the UDs 144 and other systems or devices need not maintain continual communication links 148. In other words, Users 140 by way of their UD's 144, SBPAs 100, remote sellers 156, the remote server 158 and other devices and components may log on or off at different times for different reasons.

To summarize for at least one embodiment SBPA 100 provides a lock box housing 102 defining at least one enclosable space 104 for the receipt of a package 106. The lock box housing 102 also has a sealable aperture 108 for accessing the enclosable space 104 and an electronic lock 110 structured and arranged to seal the aperture 108 and enclose the space 110. The lock box housing 102 further encloses a processor 120; at least one NPD 122 structured and arranged to actively detect a Package Attribute 134 from a package 106 proximate to the lock box housing 102; a network component 124 coupled to the processor 120; a non-volatile memory 126 coupled to the processor 120 having executable instructions to direct the operations of the NPD 122 and the electronic lock 110. The system 100 also includes a scheduler 130 structured and arranged to establish a schedule of delivery 132 within the non-volatile memory 126 including at least one Defined Characteristic 136 for the operation of the electronic lock 110 in response to the NPD 122 detecting from a proximate package 102 a Package Attribute 136 corresponding to the Defined Characteristic 136.

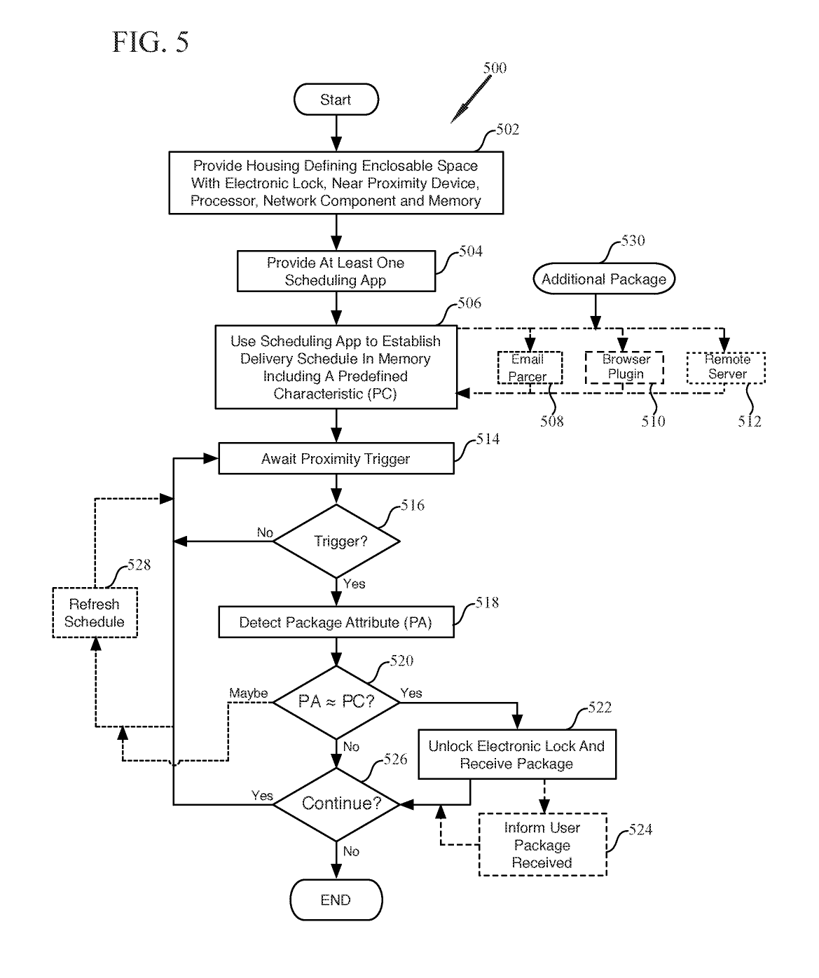

FIG. 5 in connection with FIGS. 1-4 conceptually illustrates a high level flow diagram depicting at least one method 500 for receiving by a SBPA 100 a package 106 having at least one Package Attribute 134. It will be appreciated that the described method need not be performed in the order in which it is herein described, but that this description is merely exemplary of one method 500.

In general, method 500 commences with the lock box housing 102 being provided to the user 140, block 502. In addition, at least one scheduler 130 is provided, and as noted above there may be multiple instances of the scheduler 130, block 504. As described the scheduler 130 is operable to obtain at least one element as the Defined Characteristic 136 which must correspond to the Package Attribute 134.

Moreover, as shown in block 506, the scheduler 130 is employed to establish a delivery schedule in the non-volatile memory 126 of the control circuitry 118, the delivery schedule including at least one Defined Characteristic “PC”). In one or more embodiments, the scheduler 130 is operable to obtain a first ID, such as an order number, from the email confirmation, block 508, browser text presented to the user, block 510, and/or a remote server which has received or otherwise been provided with the first ID from the remote seller, the user's email, or browser, block 512.

With the schedule now established, SBPA 100 awaits a proximity trigger, block 514. More specifically, as noted above the NPD 122 is an active device structured and arranged to detect at least one Package Attribute 134 from a package 106 proximate to the lock box housing 102. Moreover, SBPA 100 remains in a state of active readiness until a triggering event, decision 516.

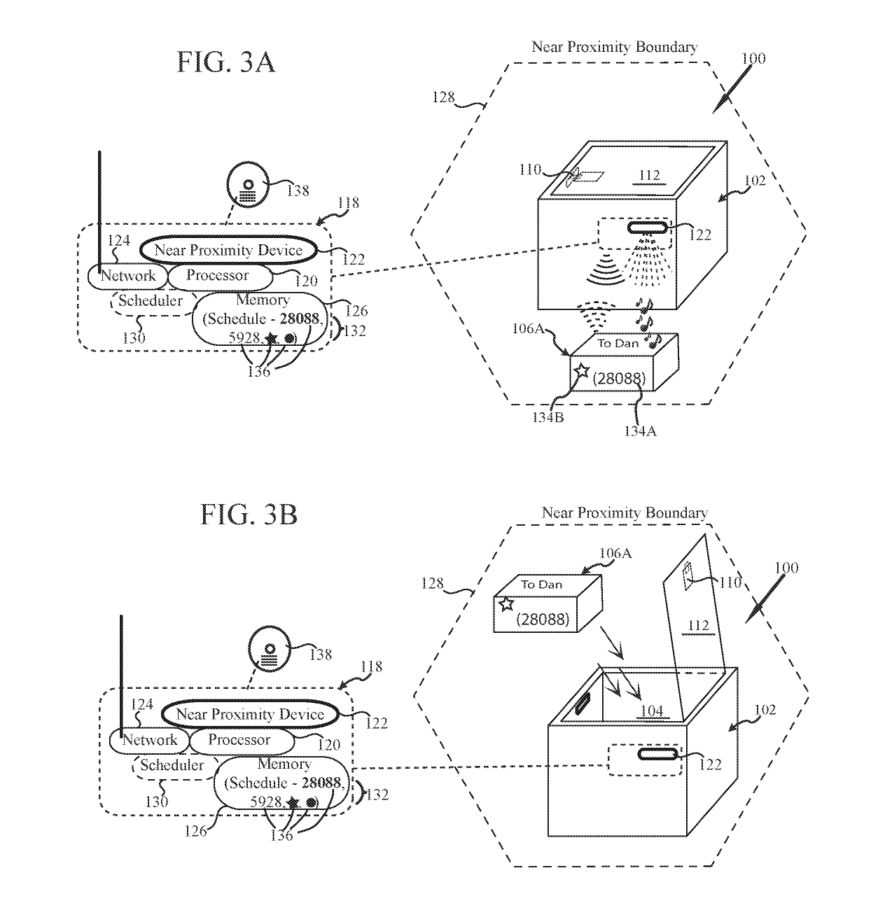

As shown in FIG. 3A a package 106A has been brought within the near proximity boundary 128 and the one or more Package Attributes 134 of package 106A are actively detected by the NPD 122, block 518 of FIG. 5. As shown in FIG. 3A, Package Attribute 134A is a star and Package Attribute 134B is a number sequence “28088”.

As the star and number sequence correspond to Defined Characteristics 136 within the delivery schedule 132, decision 520, the processor 120 will direct the electronic lock 110 to open and permit the package 106A to be disposed within the enclosable space 104 within the lock box housing 102, block 522 and shown in FIG. 3B. For at least one optional embodiment, when a package 106 is received, the processor 120 will utilize the network component 124 to direct a message to the User 140, such as by email or text message, optional block 524. Of course, for at least one embedment the User may utilize his or her UD 144 and/or the scheduler 130 to check the contents of the lock box housing 102.

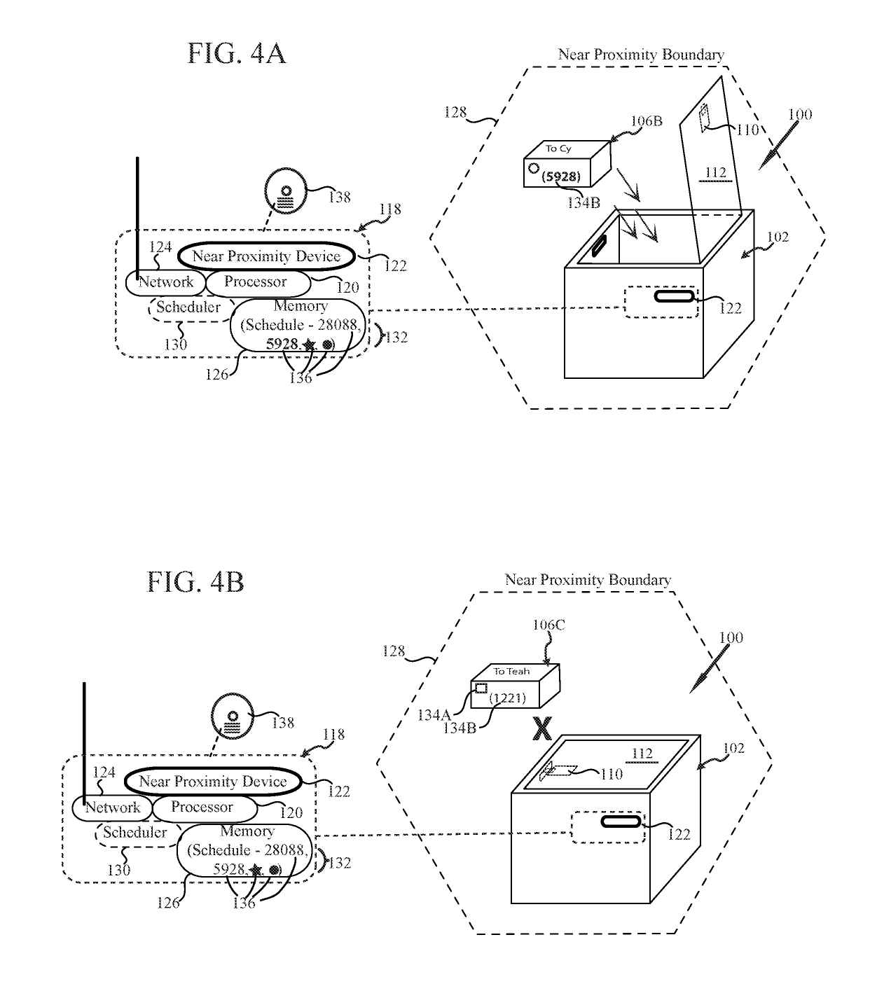

Additional packages 106 may also be received, for as shown, the delivery schedule 132 has additional Defined Characteristics 136. Moreover, as shown in FIG. 4A, package 106B has been evaluated and confirmed to have Package Attributes 134 corresponding to other Defined Characteristics 136, specifically a number sequence “5928”.

As is further shown in FIG. 4B, if a package 106C does not have a Package Attribute 134 corresponding to a Defined Characteristic 136 in the delivery schedule 132, the package 106 will be rejected and the electronic lock 110 will not be disengaged. As shown in FIG. 4B, package 106C does indeed have Package Attributes 134A and 134B, but as neither corresponds to a Defined Characteristic 136 within the delivery schedule 132, package 106C is not recognized as appropriate for receipt.

For at least one optional embodiment, if the Package Attribute 134 does not correspond with the Defined Characteristic 136, decision 520, method 500 may optionally move to refresh the schedule, block 528, as an extra measure to ensure that an intended package is not inadvertently missed. This optional feature is evidenced by the dotted line with the label “Maybe” extending from decision 520 to refresh schedule block 528.

In most situations, method 500 will continue, decision 526, and return to the active state of awaiting a proximity trigger, block 514. For at least one optional embodiment, method 500 will periodically refresh the delivery schedule by querying the remote server 158, and or the scheduler 130 installed upon at least one UD 144, the remote seller 158, a shipper's database or such other resource as may be appropriate.

When an additional package is ordered, block 530, the same processes for scheduling are triggered and the schedule of delivery 132 is once again updated.

It should be understood and appreciated that by combining various Package Attributes, such as order ID and delivery date, SBPA 100 can be fine tuned to accept a package only at a specific time, or within a specific time window. For example if medications have an expiration date SBPA 100 can be set so as to not accept delivery if the attempted delivery occurs after an expiration date. Likewise, if the User 140 has ordered an item with expedited shipping, the package 106 can be automatically refused if it arrives late—thus saving the User 140 from having to tend to the return.

Retrieval of the received package 106 by the User 140, or authorized agent of the User 140, may be accomplished in a variety of different ways according to different embodiments, such as the use of a key, the scheduler 130 as an application on the UD 144, biometric identification, or such other system of verification as may be desired.

To summarize, for at least one embodiment method 500 includes, providing a lock box housing 102 defining at least one enclosable space 104 for the receipt of a package 106, each enclosable space accessible through an aperture sealable by a door 112 at least partially attached to the lock box housing 102, each enclosable space 104 having an electronic lock 110 for engaging the door 112 with the lock box housing 102 to enclose the space 104. In addition, the lock box housing 102 further encloses a processor 120; a NPD 122 structured and arranged to actively detect at least one Package Attribute 134 from a package 106 proximate to the lock box housing 102; a network component 124 coupled to the processor 120; a non-volatile memory 126 coupled to the processor 120 having executable instructions to direct the operations of the NPD 122 and the electronic lock 110; providing at least one scheduling application 130 to establish a schedule of delivery 132 within the non-volatile memory 126 including at least one Defined Characteristic 136 for the operation of the electronic lock 110; using the scheduling application 130 to establish the schedule of delivery 132 with at least one Defined Characteristic 136; and unlocking the electronic lock in response to the NPD 122 detecting a proximate package 106 having a Package Attribute 134 corresponding to the Defined Characteristic 138.

For yet another embodiment, method 500 may be summarized as providing a lock box housing 102 defining at least one enclosable space 104 for the receipt of a package 106, each enclosable space accessible through an aperture sealable by a door 112 at least partially attached to the lock box housing 102, each enclosable space 104 having an electronic lock 110 for engaging the door 112 with the lock box housing 102 to enclose the space 104. In addition, the lock box housing 102 further encloses a processor 120; a NPD 122 structured and arranged to actively detect at least one Package Attribute 134 from a package 106 proximate to the lock box housing 102; a network component 124 coupled to the processor 120; a non-volatile memory 126 coupled to the processor 120 having executable instructions to direct the operations of the NPD 122 and the electronic lock 110; establishing a schedule of delivery 132 including at least one Defined Characteristic 138 for the operation of the electronic lock 110, the schedule established within the non-volatile memory 126; detecting a Package Attribute 134 by the NPD 122 when a package 106 having the attribute 134 is proximate to the lock box housing 102; evaluating the detected Package Attribute 134 to the Defined Characteristic 134, and unlocking the electronic lock 110 in response to the detected Package Attribute 134 corresponding to the Defined Characteristic 136.

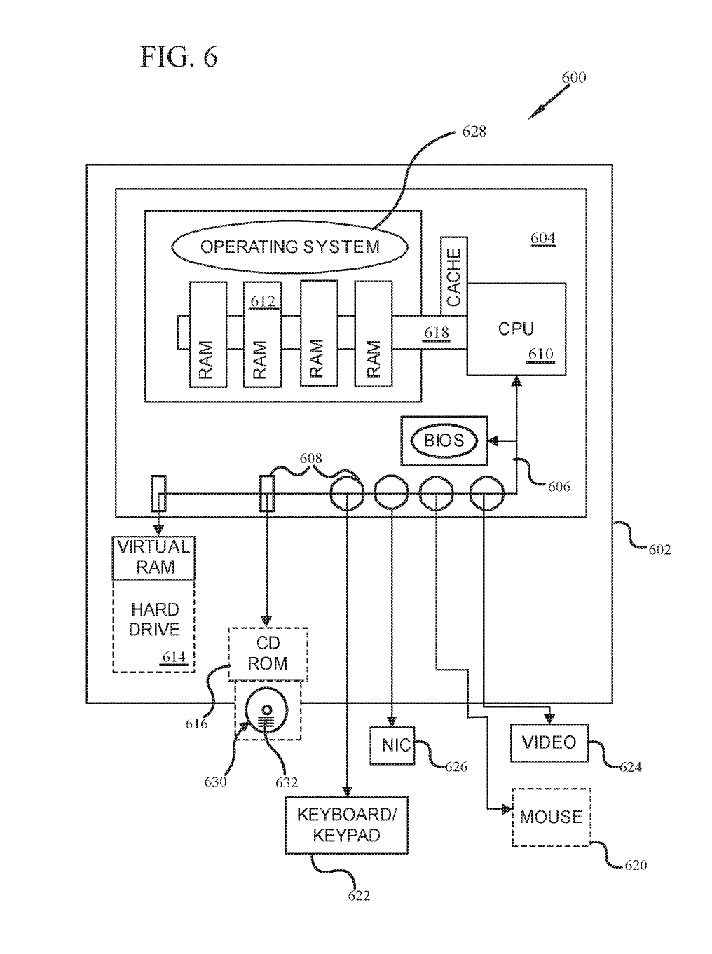

With respect to the above description of SBPA 100 and method 500, it is understood and appreciated that the method may be rendered in a variety of different forms of code and instruction as may be preferred for different computer systems and environments. To expand upon the initial suggestion of a processor based device such as control circuitry 118, User Devices 144, remote seller computer 156, remote server 158, shipper 162 and the like as shown and described with respect to the above embodiments, FIG. 6 is a high-level block diagram of an exemplary computer system 600 such as may be provided for one or more of the elements comprising the control circuitry 118, User Devices 144, remote seller computer 156, and remote server 158 whether provided as distinct individual systems or integrated together in one or more computer systems.

Computer system 600 has a case 602, enclosing a main board 604. The main board has a system bus 606, connection ports 608, a processing unit, such as Central Processing Unit (CPU) 610 and a memory storage device, such as main memory 612, and optionally a solid sate drive or hard drive 614 and/or CD/DVD ROM drive 616.

Memory bus 618 couples main memory 612 to CPU 610. In optional configurations the system bus 606 may also couple hard drive 614, CD/DVD ROM drive 616 and connection ports 608 to CPU 610. Multiple input devices may be provided, such as for example a mouse 620 and keyboard/touchpad 622. Multiple output devices may also be provided, such as for example a video display 624 and a printer (not shown). In varying embodiments, the video display may also be a touch sensitive input device. As computer system 600 is intended to be interconnected with other computer systems in the SBPA 100 a combined input/output device such as at least one network interface card, or NIC 626 is also provided.

Computer system 600 may be a commercially available system, such as a desktop workstation unit provided by IBM, Dell Computers, Gateway, Apple, Sun Micro Systems, or other computer system provider. Computer system 600 may also be a smart phone or tablet computer such as an iPhone or iPad provided by Apple, the HP Slate, the Augen or Archos Android tablets, the Motorola Xoom or other such device.

Computer system 600 may also be a networked computer system, wherein memory storage components such as hard drive 614, additional CPUs 610 and output devices such as printers are provided by physically separate computer systems commonly connected together in the network. Those skilled in the art will understand and appreciate that physical composition of components and component interconnections comprising computer system 600, and select a computer system 600 suitable for use with SBPA 100.

When computer system 600 is activated, preferably an operating system 628 will load into main memory 612 as part of the boot strap startup sequence and ready the computer system 600 for operation. At the simplest level, and in the most general sense, the tasks of an operating system fall into specific categories—process management, device management (including application and user interface management) and memory management.

In such a computer system 600, the CPU 610 is operable to perform one or more of the methods of secure package reception by a lock box with near proximity awareness. Those skilled in the art will understand that a computer-readable medium 630 on which is the remote application 120 for review, modification and/or establishing the master schedule 206 may be provided to the computer system 600. The form of the medium 630 and language of the program 632 providing the remote application 120 are understood to be appropriate for computer system 600. Utilizing the memory stores, such as for example one or more hard drives 614 and main system memory 612, the operable CPU 602 will read the instructions provided by the computer program 630 and operate to perform the remote application 120 and thereby achieve SPBA 100 as described above.

As suggested above with respect to FIG. 1, the computer program 630 may also be provided by a non-portable media such as a disc to a third party computer, such as computer 122, providing the scheduler 130 and/or scheduling application and SBPA 100 controller from platform such as but not limited to the Apple App Store. A user can then connect his or her user device 144 to the third party computer by a network (wired or wireless) through the Internet 160 other communication channel and obtain the scheduler 130 and/or scheduling application and SBPA 100 controller so as to adapt his or her UD 144 to control SPBA 100 and establish at least one schedule of deliver 132.

Changes may be made in the above methods, systems and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, system and structure, which, as a matter of language, might be said to fall there between.

What is claimed is:

1. A system for a secure lock box with near proximity awareness, comprising:
a lock box housing defining at least one enclosable space for the receipt of a package, the lock box housing having a sealable aperture for accessing the enclosable space and an electronic lock structured and arranged to seal the aperture and enclose the space, the lock box housing further enclosing:
a processor;
a near proximity device structured and arranged to actively detect a Package Attribute from a package proximate to the lock box housing;
a network component coupled to the processor;
a non-volatile memory coupled to the processor having executable instructions to direct the operations of the near proximity device and the electronic lock; and
a scheduler structured and arranged to establish a schedule of delivery within the non-volatile memory including at least one Defined Characteristic for the operation of the electronic lock in response to the near proximity device detecting from a proximate package a Package Attribute corresponding to the Defined Characteristic.

2. The system of claim 1, wherein at least one enclosable space is sealable by a door connected to the lock box housing, the lock engaging between the door and the lock box housing.

3. The system of claim 1, wherein the Defined Characteristic and the Package Attribute correspond to each other as a hash value and data.

4. The system of claim 1, wherein the Defined Characteristic is at least a portion of the Package Attribute.

5. The system of claim 1, wherein the network component is a wireless network component.

6. The system of claim 1, wherein the Defined Characteristic is a first ID number and the Package Attribute is a second ID number, the processor directing the operation of the electronic lock when the first ID number and the second ID number match.

7. The system of claim 6, wherein the first ID is a tracking number and the second ID is a tracking number.

8. The system of claim 1, wherein the near proximity device is an optical scanner, the Package Attribute rendered in a form detectable by the optical scanner.

9. The system of claim 1, wherein the near proximity device is an RFID scanner, the Package Attribute rendered in a form detectable by the RFID scanner.

10. The system of claim 1, wherein the near proximity device is sound wave detector, the Package Attribute rendered in a form detectable by the sound wave detector.

11. The system of claim 1, wherein the scheduler is a remote application provided by a user's computer as a web browser plugin, the application obtaining a tracking number as the Defined Characteristic from an order confirmation displayed to the user.

12. The system of claim 1, wherein the scheduler is a remote application provided by a user's computer and operating to parse email and obtain a tracking number as the Defined Characteristic from an order confirmation email sent to the user.

13. The system of claim 1, wherein the scheduler is established by executable instructions within the non-volatile memory.

14. The system of claim 1, wherein the scheduler is a remote application provided by a remote server having at least one processor and accessed via an internet, the remote server obtaining the Defined Characteristic relating to a package for delivery to a user.

15. The system of claim 14, wherein the remote server is operable to obtain from a shipping entity the at least one Defined Characteristic.

16. The system of claim 14, wherein the remote server is operable to obtain from a user's computer a tracking number as the Defined Characteristic from an order confirmation displayed to the user.

17. The system of claim 14, wherein the remote server is operable to obtain from a user's computer a tracking number as the Defined Characteristic from an order confirmation email sent to the user.

18. The system of claim 1, wherein the schedule of delivery further includes a time window for delivery.

19. The system of claim 1, wherein the lock box housing further includes a weight scale.

20. The system of claim 1, wherein the lock box housing further includes an internal environmental controller.

21. A system for a secure lock box with near proximity awareness, comprising:
a lock box housing defining at least one enclosable space for the receipt of a package, each enclosable space accessible through an aperture sealable by a door at least partially attached to the lock box housing, each space having an electronic lock for engaging the door with the lock box housing to enclose the space, the lock box housing further enclosing;
a processor;
a near proximity device structured and arranged to actively detect at least one Package Attribute from a package proximate to the lock box housing;
a network component coupled to the processor;
a non-volatile memory coupled to the processor having executable instructions to direct the operations of the near proximity device and the electronic lock; and
a remote scheduling application to establish via the network component a schedule of delivery within the non-volatile memory including at least one Defined Characteristic for the operation of the electronic lock in response to the near proximity device detecting from a proximate package a Package Attribute corresponding to the Defined Characteristic.

22. The system of claim 21, wherein the Defined Characteristic is a first ID number and the Package Attribute is a second ID number, the processor directing the operation of the electronic lock when the first ID number and the second ID number match.

23. The system of claim 22, wherein the first ID is a tracking number and the second ID is a tracking number.

24. The system of claim 22, wherein the Defined Characteristic and the Package Attribute correspond to each other as a hash value and data.

25. The system of claim 21, wherein the network component is a wireless network component.

26. The system of claim 21, wherein the near proximity device and the Package Attribute are selected from the group consisting of: the near proximity device is an optical scanner, the Package Attribute rendered in a form detectable by the optical scanner; the near proximity device is an RFID scanner, the Package Attribute rendered in a form detectable by the RFID scanner; the near proximity device is sound wave detector, the Package Attribute rendered in a form detectable by the sound wave detector.

27. The system of claim 21, wherein the remote application is provided by a user's computer as a web browser plugin, the application obtaining a tracking number as the Defined Characteristic from an order confirmation displayed to the user.

28. The system of claim 21, wherein the remote application is provided by a user's computer and operating to parse email and obtain a tracking number as the Defined Characteristic from an order confirmation email sent to the user.

29. The system of claim 21, wherein the remote application is provided by a remote server accessed via an internet, the remote server obtaining the Defined Characteristic relating to a package for delivery to a user.

30. The system of claim 29, wherein the remote server is operable to obtain from a shipping entity the at least one Defined Characteristic.

31. The system of claim 29, wherein the remote server is operable to obtain from a user's computer a tracking number as the Defined Characteristic from an order confirmation displayed to the user.

32. The system of claim 29, wherein the remote server is operable to obtain from a user's computer a tracking number as the Defined Characteristic from an order confirmation email sent to the user.

33. The system of claim 21, wherein the schedule of delivery further includes a time window for delivery.

34. The system of claim 21, wherein a delivery agent is a passive party, proximately placing the package adjacent to the secure lock box and disposing the package within the enclosable space upon the near proximity device detecting a Package Attribute corresponding to the Defined Characteristic.

35. The system of claim 21, the lock box housing defining a plurality of enclosable spaces each having a separate door with electronic lock, each enclosable space, door and electronic lock combination having it's own Defined Characteristic for the operation of the electronic lock.

36. A method for receipt of a package by a secure lock box with near proximity awareness, comprising:
providing a lock box housing defining at least one enclosable space for the receipt of a package, each enclosable space accessible through an aperture sealable by a door at least partially attached to the lock box housing, each enclosable space having an electronic lock for engaging the door with the lock box housing to enclose the space, the lock box housing further enclosing:
a processor;
a near proximity device structured and arranged to actively detect at least one Package Attribute from a package proximate to the lock box housing;
a network component coupled to the processor;
a non-volatile memory coupled to the processor having executable instructions to direct the operations of the near proximity device and the electronic lock;
providing at least one scheduling application to establish a schedule of delivery within the non-volatile memory including at least one Defined Characteristic for the operation of the electronic lock;
using the scheduling application to establish the schedule of delivery with at least one Defined Characteristic; and
unlocking the electronic lock in response to the near proximity device detecting a proximate package having a Package Attribute corresponding to the Defined Characteristic.

37. The method of claim 36, wherein the Defined Characteristic is a first ID number and the Package Attribute is a second ID number.

38. The method of claim 36, wherein the scheduling application is a remote application provided by a user's computer as a web browser plugin, the application obtaining a tracking number as the Defined Characteristic from an order confirmation displayed to the user.

39. The method of claim 36, wherein the near proximity device and the Package Attribute are selected from the group consisting of: the near proximity device is an optical scanner, the Package Attribute rendered in a form detectable by the optical scanner; the near proximity device is an RFID scanner, the Package Attribute rendered in a form detectable by the RFID scanner; the near proximity device is sound wave detector, the Package Attribute rendered in a form detectable by the sound wave detector.

40. The method of claim 36, wherein the scheduling application is a remote application provided by a user's computer and operating to parse email and obtain a tracking number as the Defined Characteristic from an order confirmation email sent to the user.

41. The method of claim 36, wherein the scheduling application is a remote application provided by a remote server having at least one processor and accessed via an internet, the remote server obtaining the Defined Characteristic relating to a package for delivery to a user.

42. The method of claim 41, wherein the remote server is operable to obtain from a shipping entity the at least one Defined Characteristic.

43. The method of claim 41, wherein the remote server is operable to obtain from a user's computer a tracking number as the Defined Characteristic from an order confirmation displayed to the user.

44. The method of claim 41, wherein the remote server is operable to obtain from a user's computer a tracking number as the Defined Characteristic from an order confirmation email sent to the user.

45. The method of claim 36, wherein a delivery agent is a passive party, proximately placing the package adjacent to the secure lock box and disposing the package within the enclosable space upon the near proximity device detecting a Package Attribute corresponding to the Defined Characteristic.

46. The method of claim 36, wherein the schedule of delivery further includes a time window for delivery.

47. A method for receipt of a package by a secure lock box with near proximity awareness, comprising:
providing a lock box housing defining at least one enclosable space for the receipt of a package, each enclosable space accessible through an aperture sealable by a door at least partially attached to the lock box housing, each space having an electronic lock for engaging the door with the lock box housing to enclose the space, the lock box housing further enclosing:
a processor;
a near proximity device structured and arranged to actively detect at least one Package Attribute from a package proximate to the lock box housing;
a network component coupled to the processor;
a non-volatile memory coupled to the processor having executable instructions to direct the operations of the near proximity device and the electronic lock;
establishing a schedule of delivery including at least one Defined Characteristic for the operation of the electronic lock, the schedule established within the non-volatile memory;
detecting a Package Attribute by the near proximity device when a package having the attribute is proximate to the lock box housing;
evaluating the detected Package Attribute to the Defined Characteristic, and unlocking the electronic lock in response to the detected Package Attribute corresponding to the Defined Characteristic.

48. The method of claim 47, wherein the Defined Characteristic is a first ID number and the Package Attribute is a second ID number.

49. The method of claim 47, wherein the near proximity device and the Package Attribute are selected from the group consisting of: the near proximity device is an optical scanner, the Package Attribute rendered in a form detectable by the optical scanner; the near proximity device is an RFID scanner, the Package Attribute rendered in a form detectable by the RFID scanner; the near proximity device is sound wave detector, the Package Attribute rendered in a form detectable by the sound wave detector.

50. The method of claim 47, wherein establishing scheduling includes periodic polling of shipping company databases for packages intended for delivery to a user of the secure lock box.

51. The method of claim 47, wherein establishing a schedule of delivery includes providing at least one remote scheduling application to establish via the network component the schedule of delivery within the non-volatile memory including the least one Defined Characteristic for the operation of the electronic lock.

52. The method of claim 51, wherein a delivery agent is a passive party, proximately placing the package adjacent to the secure lock box and disposing the package within the enclosable space upon the near proximity device detecting a Package Attribute corresponding to the Defined Characteristic.
